(19) United States
(12) Patent Application Publication
(10) Pub. No.: US 2017/0138251 A1
(43) Pub. Date: May 18, 2017

(54) PRE-CHAMBER NOZZLE

(71) Applicant: Cummins Inc., Columbus, IN (US)

(72) Inventors: Atsuhiko Watanabe, London (GB); Patrick M. Pierz, Hood River, OR (US); Darren Ting, Columbus, IN (US)

(21) Appl. No.: 14/939,572

(22) Filed: Nov. 12, 2015

(51) Int. Cl. F02B 19/18; F02B 19/12

(52) U.S. Cl. CPC F02B 19/18; F02B 19/12

(57) ABSTRACT

An engine includes a cylinder having an internal combustion chamber and extending longitudinally, a cylinder head coupled to the cylinder, and a fuel-fed pre-chamber positioned within a portion of the cylinder head. The pre-chamber includes a pre-chamber volume and plurality of nozzle holes extending from the pre-chamber volume. The engine also includes an ignition source positioned longitudinally above the pre-chamber volume and a locating member positioned on at least one of the pre-chamber and the cylinder head. The locating member is configured to position the pre-chamber in a predetermined orientation within the cylinder head.

### FIELD OF THE INVENTION

The present disclosure relates to a fuel assembly for an internal combustion engine, and more particularly, to a pre-chamber fuel device of a fuel assembly.

### BACKGROUND OF THE DISCLOSURE

An internal combustion engine may include at least one cylinder, a cylinder head coupled to the cylinder, at least one intake valve operably coupled to the cylinder head, and at least one exhaust valve operably coupled to the cylinder head. On engines with multiple intake and exhaust valves, the portion of the cylinder head between the exhaust valves, i.e., the exhaust bridge (“E-E bridge”), may be hotter than the portion of the cylinder head between the intake valves, i.e., the intake bridge (“I-I bridge”), and the portion of the cylinder head between one of the intake valves and one of the exhaust valves, i.e., the intake-exhaust bridge (“I-E bridge”), due to the elevated temperature of the exhaust gases exiting the cylinder.

Additionally, during combustion within the cylinder, the flame jets which initiate combustion also increase the temperature of the portions of the cylinder and cylinder head adjacent the jets. For example, any flame jets adjacent the E-E bridge of the cylinder head further increase the temperature thereof during combustion. As such, there is a need for orienting or directing flame jets away from the hottest portions of the cylinder and/or cylinder head to decrease the temperature thereof during operation of the engine.

### SUMMARY OF THE DISCLOSURE

In one embodiment, an engine comprises a cylinder having an internal combustion chamber and extending longitudinally, a cylinder head coupled to the cylinder, and a fuel-fed pre-chamber positioned within a portion of the cylinder head. The pre-chamber includes a pre-chamber volume and plurality of nozzle holes extending from the pre-chamber volume. The engine also comprises an ignition source positioned longitudinally above the pre-chamber volume and a locating member positioned on at least one of the pre-chamber and the cylinder head. The locating member is configured to position the pre-chamber in a predetermined orientation within the cylinder head.

In a further embodiment, an engine comprises a cylinder having a cylinder bore and extending along a longitudinal axis of the cylinder, a cylinder head coupled to the cylinder, and a fuel-fed pre-chamber positioned within a portion of the cylinder head. The pre-chamber includes a pre-chamber volume and plurality of nozzle holes extending from the pre-chamber volume. The plurality of nozzle holes have an asymmetrical configuration at a distal portion of the pre-chamber. The engine also comprises an ignition source positioned longitudinally above the pre-chamber volume.

In another embodiment, an engine comprises a cylinder extending along a longitudinal axis, a cylinder head coupled to the cylinder, and a pre-chamber positioned within a portion of the cylinder head. The pre-chamber includes a pre-chamber volume and plurality of nozzle holes extending from the pre-chamber volume. The engine also comprises at least one electronic fuel valve fluidly coupled to the pre-chamber volume.

In a further embodiment, a locating member is configured to maintain a longitudinal and rotational position of the pre-chamber. Additionally, the locating member may include a first locating member positioned on the pre-chamber and a second locating member positioned on the cylinder head.

In another embodiment, the first and second locating members are selected from the group consisting of a pin, a notch, a protrusion, a flat screw, a set screw, a tab, a recess, a shoulder, and a groove.

In a further embodiment, a plurality of nozzle holes are asymmetrically distributed about the pre-chamber. Additionally, the plurality of nozzle holes includes a first portion of nozzle holes positioned at a first portion of the pre-chamber and a second portion of nozzle holes positioned at a second portion of the pre-chamber, and the first portion of nozzle holes includes more nozzle holes than the second portion of nozzle holes.

In another embodiment, a plurality of nozzle holes includes a first portion of nozzle holes positioned at a first portion of the pre-chamber and a second portion of nozzle holes positioned at a second portion of the pre-chamber, and each nozzle hole of the first portion has a greater diameter than each of nozzle hole of the second portion.

In a further embodiment, a diameter of the at least one nozzle hole is 0.5-2.0% of a diameter of the cylinder bore.

In another embodiment, a circumferential separation between a first portion of the plurality of nozzle holes is greater than a circumferential separation between a second portion of the plurality of nozzle holes.

In a further embodiment, an angle relative to the longitudinal axis of the cylinder of at least one nozzle hole is greater than an angle relative to the longitudinal axis of the cylinder of a remainder of the nozzle holes.

In a further embodiment, a retaining clamp is configured to retain the pre-chamber within the cylinder head and positioned longitudinally above the pre-chamber volume.

In another embodiment, a fuel conduit fluidly is coupled to the at least one electronic fuel valve and the pre-chamber volume and having a length 1-5 times greater than an inner diameter of the fuel conduit. Additionally, the length of the fuel conduit may be 1-3 times greater than the inner diameter of the fuel conduit.

In a further embodiment, the ignition source is a spark plug retained within the pre-chamber.

In another embodiment, a plurality of nozzle holes are in an asymmetrical configuration at a distal portion of the pre-chamber.

### BRIEF DESCRIPTION OF THE DRAWINGS

The above mentioned and other features of this invention, and the manner of attaining them, will become more apparent and the invention itself will be better understood by reference to the following description of embodiments of the invention taken in conjunction with the accompanying drawings, where:

FIG. 1 is a cross-sectional view of a cylinder of an engine of the present disclosure;

FIG. 2 is a top view of a cylinder head of the cylinder of FIG. 1;

FIG. 3 is a perspective view of a pre-chamber assembly positioned within a portion of the cylinder head of FIG. 2;

FIG. 4 is an exploded view of a spark plug, fuel control member, and the pre-chamber assembly of FIG. 3;

FIG. 5 is a cross-sectional view of the spark plug, fuel control member, and pre-chamber assembly of FIG. 4, taken along line 5-5 of FIG. 3;

FIG. 6 is a cross-sectional view of a portion of the spark plug, fuel control member, and pre-chamber assembly of FIG. 4, taken along line 6-6 of FIG. 3;

FIG. 7 is a perspective view of a pre-chamber nozzle including a locating feature and nozzle openings;

FIG. 8A is a cross-sectional view of the pre-chamber nozzle of FIG. 7, taken along line 8-8 of FIG. 7, and disclosing one embodiment of asymmetrical nozzle openings;

FIG. 8B is a cross-sectional view of the pre-chamber nozzle of FIG. 7, taken along line 8-8 of FIG. 7, and disclosing another embodiment of asymmetrical nozzle openings; and

FIG. 8C is a cross-sectional view of the pre-chamber nozzle of FIG. 7, taken along line 8-8 of FIG. 7, and disclosing a further embodiment of asymmetrical nozzle openings.

### DETAILED DESCRIPTION OF THE DRAWINGS

The embodiments disclosed below are not intended to be exhaustive or to limit the invention to the precise forms disclosed in the following detailed description. Rather, the embodiments are chosen and described so that others skilled in the art may utilize their teachings.

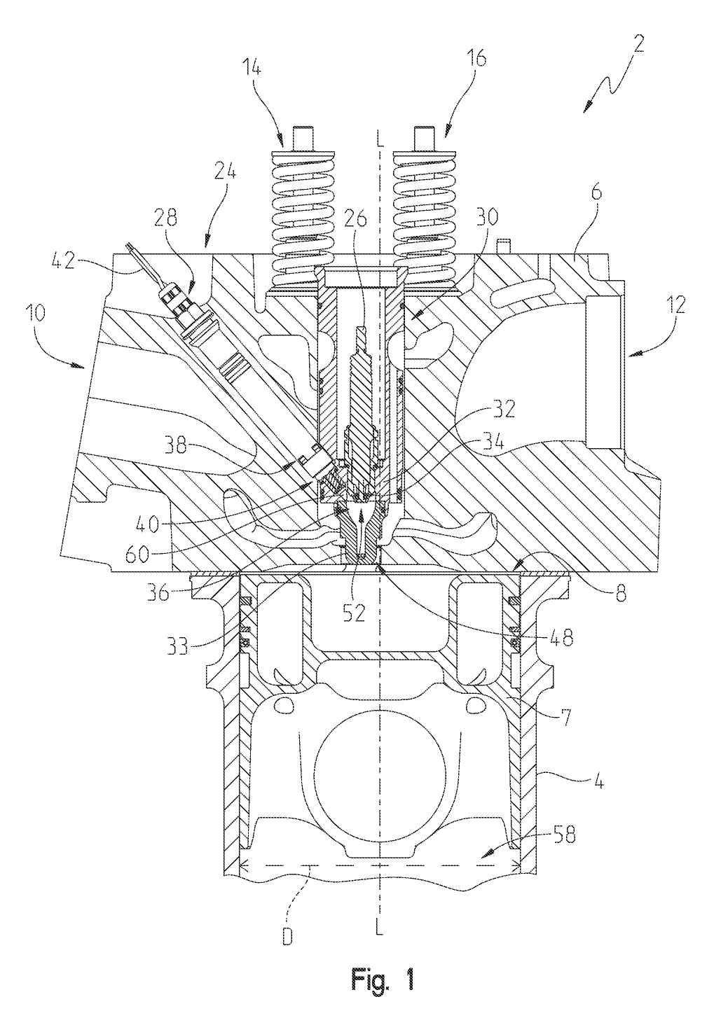

Referring to FIG. 1, an engine 2 may be an internal combustion engine which includes a cylinder 4, a cylinder head 6 sealingly coupled to cylinder 4, and a piston 7 configured to reciprocate within cylinder 4. A main combustion chamber 8 is defined within cylinder 4 above piston 7. Main combustion chamber 8 may be generally defined by the inner cylindrical diameter of cylinder 4 and the upper surface, including the bowl, of piston 7. More particularly, cylinder 4 includes a cylinder bore 58 which receives piston 7 and defines the inner diameter of cylinder 4. Cylinder bore 58 has a diameter D which also defines the diameter of main combustion chamber 8.

Engine 2 also includes an intake port 10 extending through a portion of cylinder head 6 and fluidly coupled to main combustion chamber 8, an exhaust port 12 extending through a portion of cylinder head 6 and fluidly coupled to main combustion chamber 8, at least one intake valve 14 operably coupled to cylinder head 6 and intake port 10, and at least one exhaust valve 16 operably coupled to cylinder head 6 and exhaust port 12.

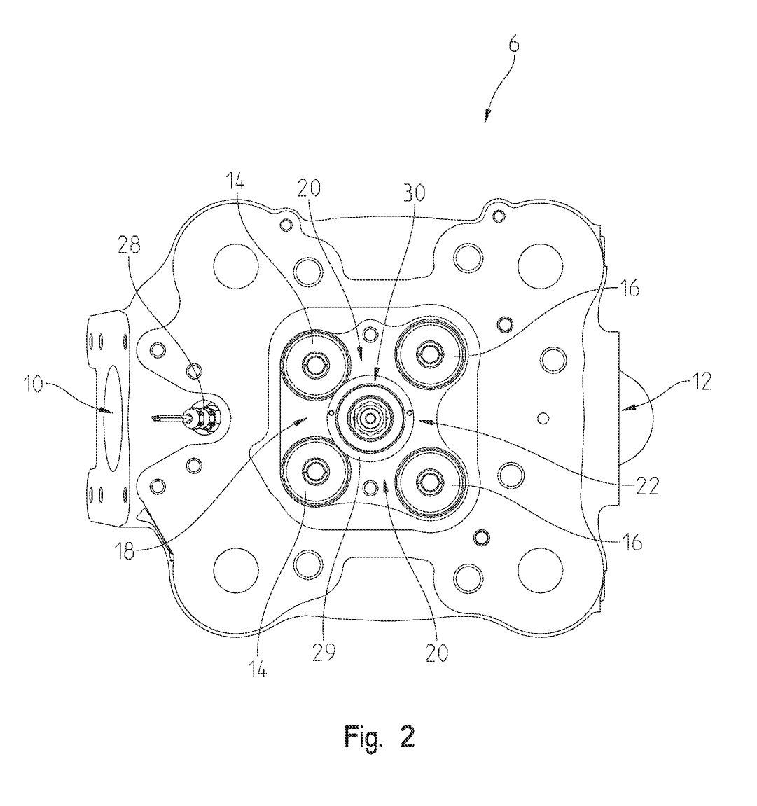

Illustratively, as shown in FIG. 2, engine 2 includes at least two intake valves 14 and at least two exhaust valves 16. The portion of cylinder head 6 extending between intake valves 14 is defined as an intake bridge (“I-I bridge”) 18, the portion of cylinder head 6 extending between intake valve 14 and exhaust valve 16 is defined as an intake-exhaust bridge (“I-E bridge”) 20, and the portion of cylinder head 6 extending between exhaust valves 16 is defined as an exhaust bridge (“E-E bridge”) 22.

During operation of engine 2, the temperature of the exhaust gases exiting main combustion chamber 8 through exhaust port 12 may be elevated relative to the temperature of the intake air entering main combustion chamber 8 through intake port 10. As such, the temperature at E-E bridge 22 of cylinder head 6 may be greater than the temperature at I-I bridge 18 and/or I-E bridge 20, as disclosed further herein. Increased temperatures in portions of engine 2, such as at or adjacent E-E bridge 22, may undesirably increase the likelihood that knock will occur in cylinder 4. As disclosed further herein, certain aspects of engine 2 are configured to direct heat away from E-E bridge 22 to reduce the likelihood of knock.

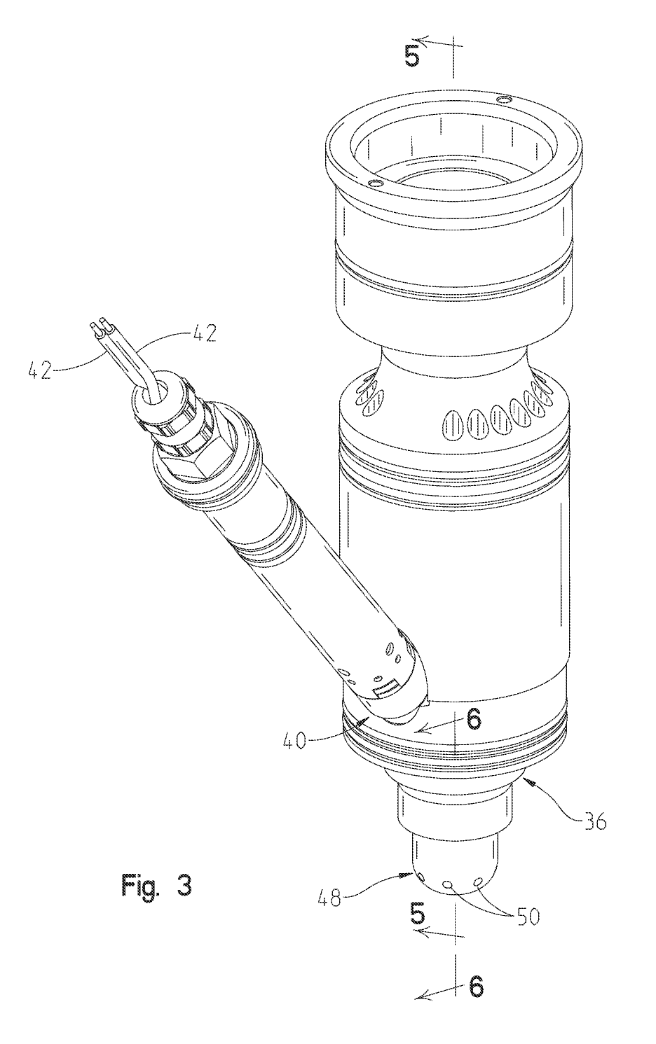

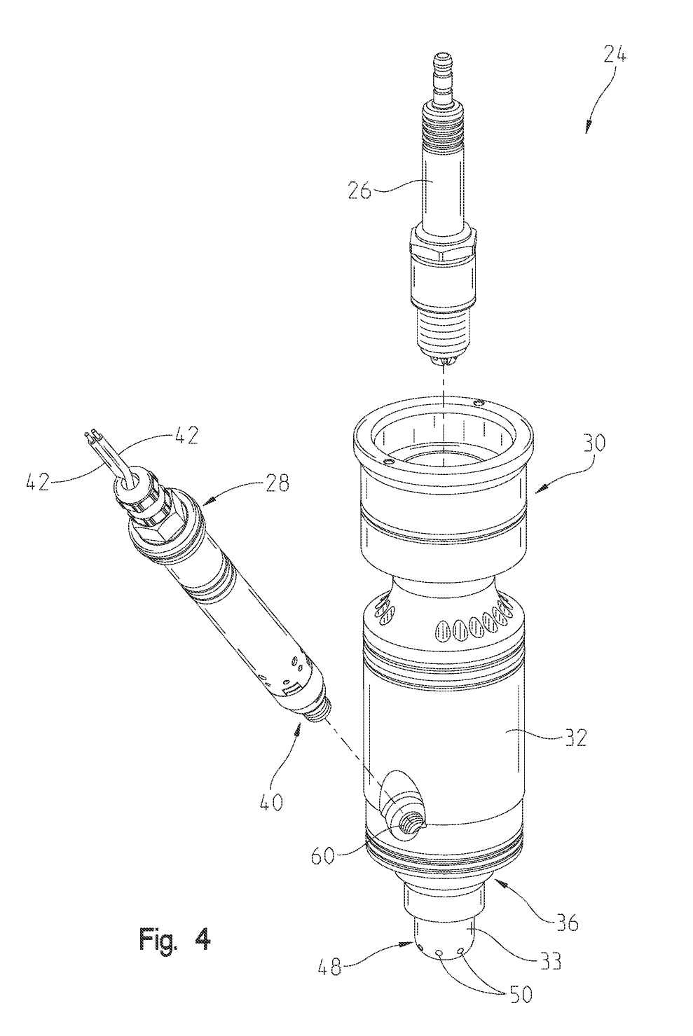

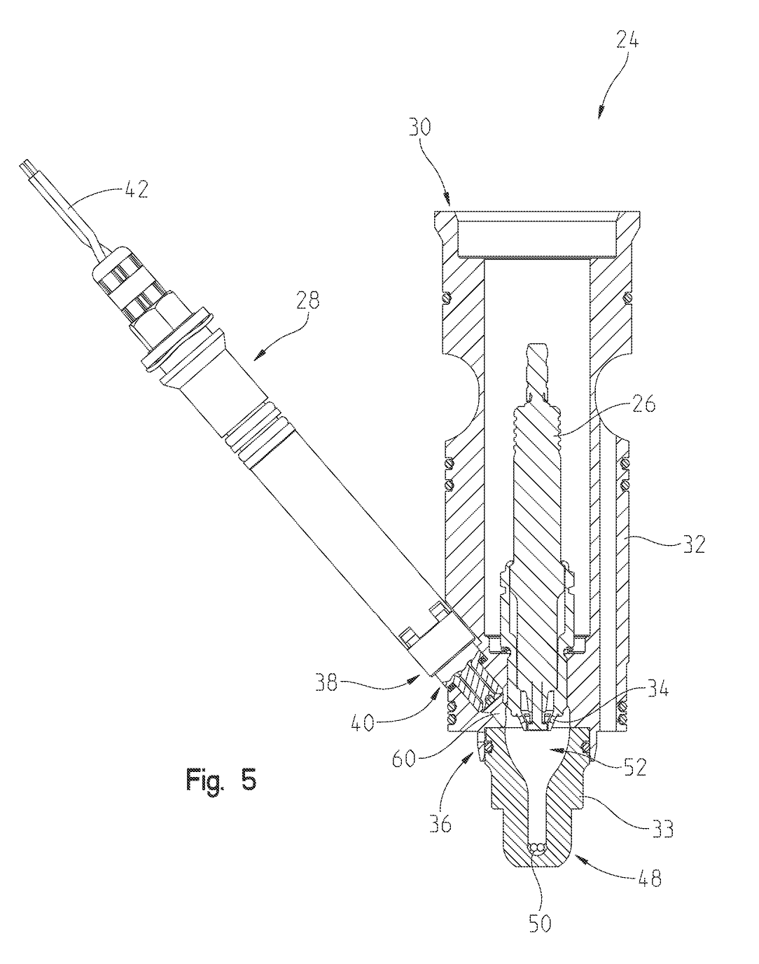

Referring to FIGS. 1-8, engine 2 also includes a fuel assembly 24 which includes at least an ignition source, illustratively a spark plug 26, a fuel injector 28, and a pre-chamber assembly 30 including a pre-chamber housing 32 and a pre-chamber nozzle 33. Pre-chamber assembly 30 may be a fuel-fed pre-chamber assembly, a passive pre-chamber assembly, or any other type of pre-chamber assembly. Illustratively, housing 32 extends generally through a center portion of cylinder head 6 and, in one embodiment, extends along a longitudinal axis L of cylinder 4 (FIG. 1). Housing 32 is configured to receive spark plug 26 which may be retained within housing 32 by an overhead clamp 29 (FIG. 2). A distal end 34 of spark plug 26 may extend into an upper or proximal portion 36 of pre-chamber nozzle 33, as shown in FIGS. 1, 5, and 6. As such, spark plug 26 is positioned longitudinally above pre-chamber nozzle 33 and is generally parallel or collinear with longitudinal axis L. However, spark plug 26 also may be positioned at an angle relative to longitudinal axis L.

Referring still to FIGS. 1-6, fuel injector 28 extends through a portion of cylinder head 6 and may be positioned within intake port 10 to supply fuel (e.g., diesel, natural gas, gasoline, etc.) to the intake air when intake valve 14 is open. In one embodiment, fuel injector 28 is angled relative to spark plug 26, housing 32, and longitudinal axis L of cylinder 4. The quantity of fuel supplied to intake port 10 may be approximately 90-99% of the total fuel supplied during a fuel injection event or cycle and, more particularly, may be approximately 97-99% of the total fuel. As such, the remaining 1-10% and, more particularly 1-3%, of the total fuel is introduced into pre-chamber nozzle 33 either directly or after mixing with air to create a charge.

Fuel injector 28 may be electronically operated and includes an electronic fuel valve 38 at a distal end 40 thereof. Illustratively, fuel valve 38 may be an electronically-actuated poppet valve. As shown in FIGS. 1, 5, and 6, fuel valve 38 may be generally adjacent spark plug 26 and may be generally flush with pre-chamber nozzle 33 or spaced a short distance therefrom by a passageway 60. In one embodiment, a length 62 of passageway 60 may be approximately 1-5 times an inner diameter 64 of passageway 60 and, more particularly, approximately 1-3 times inner diameter 64. For example, fuel valve 38 may be spaced from an internal pre-chamber volume 52 of pre-chamber nozzle 33 by length 62 of passageway 60. By positioning fuel valve 38 directly adjacent pre-chamber nozzle 33 (e.g., either flush with pre-chamber nozzle 33 or spaced by a short distance), pre-chamber housing 32 does not include a long passage between fuel valve 38 and pre-chamber nozzle 33 which reduces the likelihood of flame quench and residual unburnt fuel. However, fuel valve 38 does not extend into pre-chamber volume 52 of pre-chamber nozzle 33 because that would expose fuel valve 38 to increased heat which may damage the electronic components of fuel valve 38. As such, fuel valve 38 may be flush with, spaced apart from, or extend into the body of pre-chamber nozzle 33 but is spaced apart from pre-chamber volume 52.

In one embodiment, fuel valve 38 may be electronically coupled to any electrical component(s) of engine 2 (e.g., an engine control unit) through a wired connection with wires 42 or through a wireless or other connection. In this way, fuel valve 38 may be electronically controlled to monitor and control the amount and timing of fuel distributed to main combustion chamber 8 through pre-chamber nozzle 33. Because fuel valve 38 may be electronically controlled, rather than mechanically controlled, the quantity and timing of the fuel distribution to main combustion chamber 8 may be more efficient and effective.

As shown in FIGS. 1 and 3-6, pre-chamber nozzle 33 extends longitudinally from housing 32. Illustratively, upper portion 36 of pre-chamber nozzle 33 is coupled to housing 32 and/or cylinder head 6 and a lower or distal portion 48 of pre-chamber nozzle 33 is positioned adjacent main combustion chamber 8 of cylinder 4. Pre-chamber volume 52 is defined generally between upper and lower portions 36, 48 and is configured to receive a small quantity of fuel from fuel injector 28 to create a small charge (i.e., a mixture of fuel and air) adjacent spark plug 26 which forms flame jets that directly extend from pre-chamber nozzle 33 into main combustion chamber 8 when the charge is ignited by spark plug 26. In one embodiment, pre-chamber volume 52 is approximately 0.5-2.0% of the total volume of cylinder bore 58 when piston 7 is at top-dead-center (“TDC”).

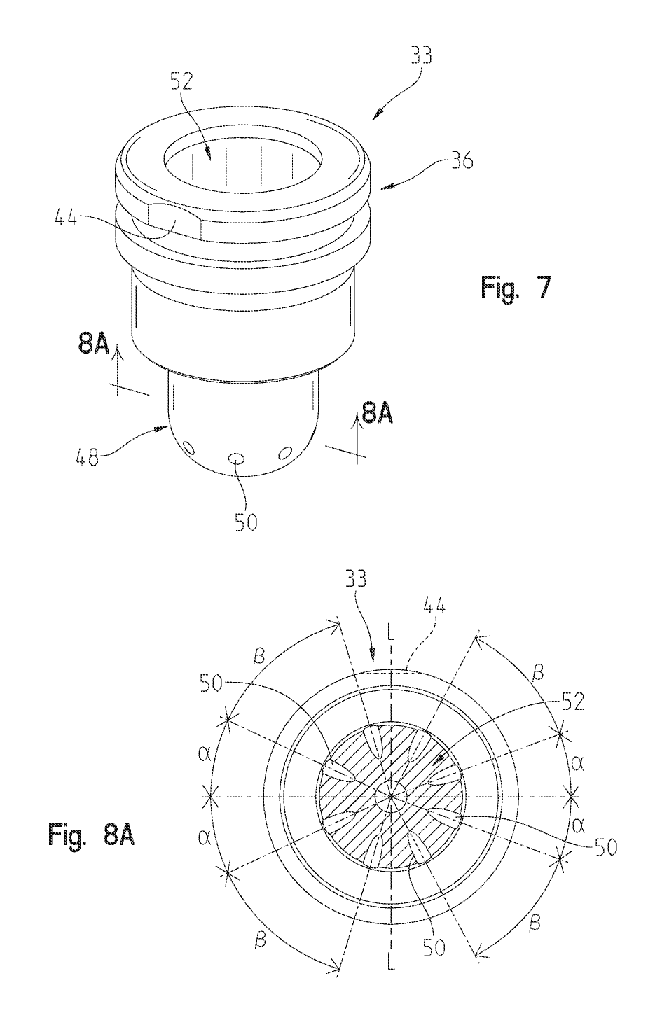

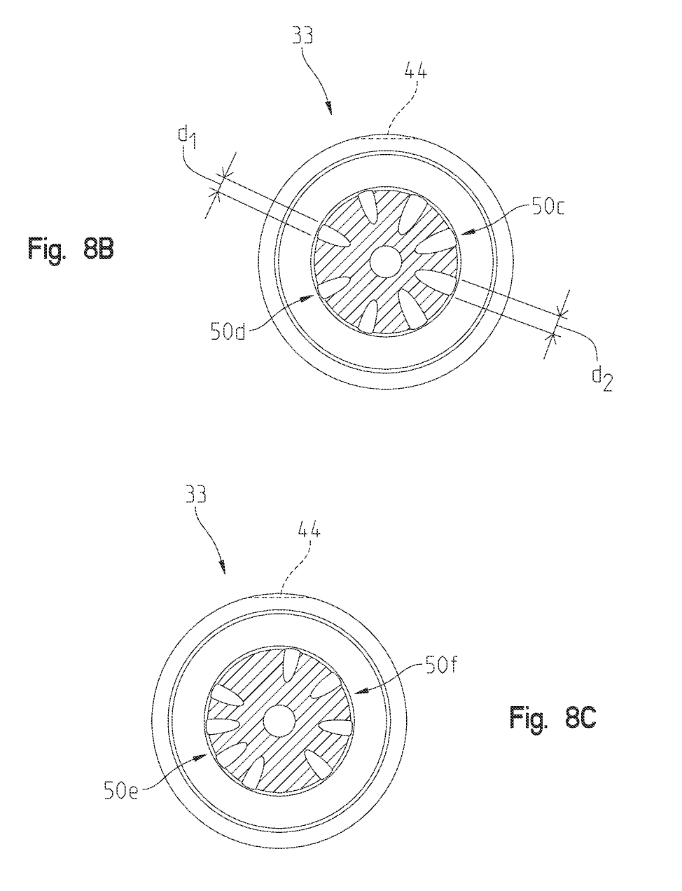

Referring to FIG. 7, lower portion 48 of pre-chamber nozzle 33 includes at least one nozzle hole or opening 50 and, in one embodiment, includes a plurality of nozzle openings 50 for supplying fuel to main combustion chamber 8. Illustratively, pre-chamber nozzle 33 includes 6-12 nozzle openings 50. Nozzle openings 50 may be evenly distributed about lower portion 48 of pre-chamber nozzle 33 to form a symmetric distribution pattern of fuel. Alternatively, and as shown in FIG. 8A, nozzle openings 50 may be asymmetrically configured about lower portion 48 of pre-chamber nozzle 33 by varying the angle of at least one nozzle opening 50 relative to longitudinal axis L of cylinder 4. Illustratively, at least one opening 50a may be angled approximately 15-30° relative to longitudinal axis L, as shown by angle α. Additionally, the remaining nozzle opening(s) 50b may have the same angle as opening 50a or may have a different angle than opening 50a relative to longitudinal axis L. For example, nozzle opening(s) 50b may be angled approximately 30-55° relative to longitudinal axis L. As such, the spray angle of some of nozzle openings 50 is shallower or deeper relative to other nozzle openings 50. In this way, the asymmetrical spray angle configuration of nozzle openings 50 may be provided to direct the flame jets toward cooler portions of cylinder 4 and/or cylinder head 6 to increase combustion and reduce the likelihood of knock.

Alternatively, and as shown in FIG. 8B, nozzle openings 50 may be asymmetrically distributed about lower portion 48 of pre-chamber nozzle 33 by including at least one opening 50c with a larger diameter than the remaining openings 50d. Illustratively, openings 50d have a diameter d₁ at the inner surface of pre-chamber nozzle 33 which may be approximately 0.5-2.0% of diameter D of cylinder bore 58. However, opening(s) 50c have a larger diameter d₂ at the inner surface of pre-chamber nozzle 33 relative to diameter d₁ which may be approximately 2.0-5.0% of diameter D of cylinder bore 58. As such, the diameter of some of nozzle openings 50 is greater or smaller relative to other nozzle openings 50. In this way, the asymmetrical nozzle diameter configuration of nozzle openings 50 may be provided to direct the flame jets toward cooler portions of cylinder 4 and/or cylinder head 6 to increase combustion and reduce the likelihood of knock.

In an alternative embodiment shown in FIG. 8C, nozzle openings 50 of pre-chamber nozzle 33 may be asymmetrically distributed about lower portion 48 of pre-chamber nozzle 33. In one embodiment, a first portion 50e of nozzle openings 50 may be positioned at a first portion of pre-chamber nozzle 33 and a second portion 50f of nozzle openings 50 may be positioned at a second portion of pre-chamber nozzle 33. As shown in FIG. 8C, nozzle openings 50 of first portion 50e are spaced circumferentially closer together than nozzle openings 50 of second portion 50f such that a circumferential separation between nozzle openings 50 of first portion 50e is less than a circumferential separation of nozzle openings 50 of second portion 50f. As such, some of nozzle openings 50 are clustered closer together relative to other nozzle openings 50. In this way, the asymmetrical nozzle diameter configuration of nozzle openings 50 may be provided to direct the flame jets toward cooler portions of cylinder 4 and/or cylinder head 6 to increase combustion and reduce the likelihood of knock.

By asymmetrically distributing nozzle openings 50 about pre-chamber nozzle 33 as disclosed in any of the embodiments herein, the flame jets formed in pre-chamber nozzle 33 during a fuel cycle may be directed into main combustion chamber 8 in a predetermined output path. For example, and disclosed further herein, the asymmetrical distribution of nozzle openings 50 may direct flame jets away from E-E bridge 22 or otherwise may direct the flame jets toward I-E bridge 20 or I-I bridge 18. More particularly, the flame jets may concentrate combustion and, therefore heat, in particular areas of main combustion chamber 8, thereby creating uneven heating and uneven combustion therein. However, by predetermining the direction and, therefore the concentration, of the flame jets within main combustion chamber 8, an increase in the uniformity of heating and/or combustion within main combustion chamber 8 may be achieved. In this way, the asymmetric distribution of nozzle openings 50 compensates for any asymmetry in heating and/or combustion within main combustion chamber 8 which decreases the likelihood that knock will occur. For example, larger concentrations of nozzle openings 50, nozzle openings 50 with larger diameters, and/or nozzle openings 50 with a decreased angle relative to longitudinal axis L of cylinder 4 may be oriented toward cooler portions of cylinder 4 and cylinder head 6 to increase combustion at these portions while small concentrations of nozzle openings 50, nozzle openings 50 with smaller diameters, and/or nozzle openings 50 with a greater angle relative to longitudinal axis L of cylinder 4 may be oriented toward hotter portions of cylinder 4 and cylinder head 6 to decrease the temperature and amount of combustion at these portions.

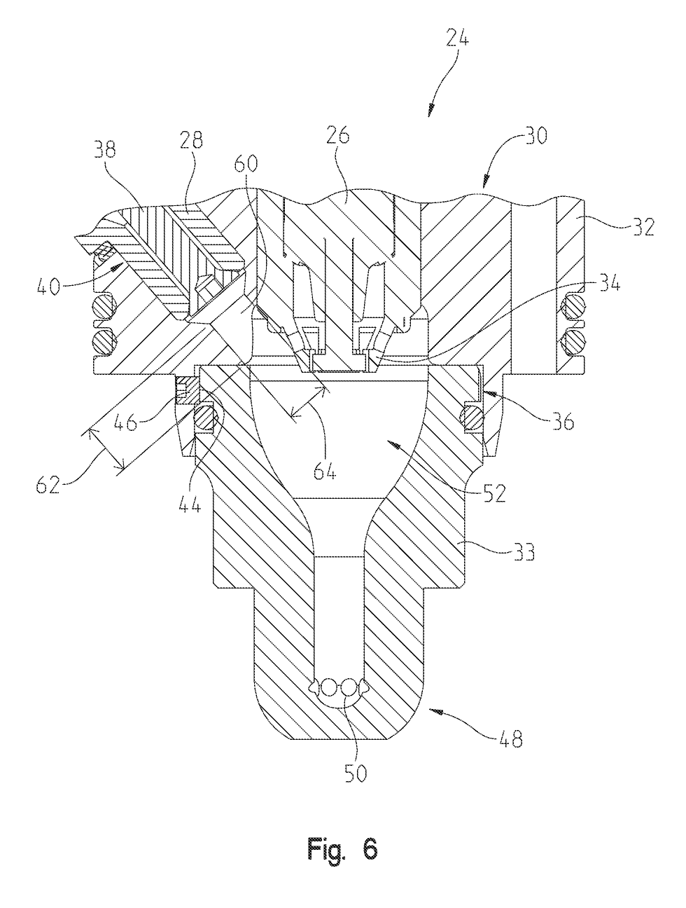

Referring to FIGS. 6-8C, upper portion 36 of pre-chamber nozzle 33 is coupled to housing 32 and/or cylinder head 6 in at least one pre-determined orientation. For example, pre-chamber nozzle 33 may include at least a first locating member 44 configured to couple with at least a second locating member 46 (FIG. 6) on housing 32 and/or cylinder head 6 to orient pre-chamber nozzle 33 in at least one predetermined configuration. In one embodiment, first locating member 44 may be a pin, screw (e.g., flat screw or set screw), shoulder, tab, flange, or any other type of protrusion or, alternatively, may be a groove, slot, notch, indentation, flat surface, or recess. Additionally, second locating member 46 also may be a pin, flat screw, set screw, tab, shoulder, flange, or any other type of protrusion configured to receive or couple with first locating member 44 or, alternatively, may be a groove, slot, notch, indentation, or recess configured to receive or couple with first locating member 44. In one embodiment, first locating member 44 defines an indentation or flat surface of pre-chamber nozzle 33 and second locating member 46 defines a set screw.

By providing first and second locating members 44, 46, pre-chamber nozzle 33 is oriented according to the location(s) of locating members 44, 46 because first locating member 44 couples with or otherwise complements second locating member 46 to secure pre-chamber nozzle 33 to housing 32 and/or cylinder head 6. The predetermined orientation of pre-chamber nozzle 33 according to the positions of locating members 44, 46 fixes the rotational, longitudinal, and/or angular orientation of nozzle openings 50 of pre-chamber nozzle 33 to direct flame jets in a particular direction or toward a particular portion of main combustion chamber 8 during a fuel injection cycle. In this way, the flame jets from nozzle openings 50 are oriented for increased combustion due to increased turbulence within particular portions of main combustion chamber 8 and/or to direct the heat resulting from the flame jets and/or combustion away from other components of engine 2 which experience more heat, such as E-E bridge 22.

In one embodiment, pre-chamber nozzle 33 includes a plurality of first locating members 44 and/or cylinder head 6 or housing 32 also includes a plurality of locating members 46 such that pre-chamber nozzle 33 may be oriented in a plurality of predetermined configurations. As such, the orientation of pre-chamber nozzle 33 during installation of fuel assembly 24 with engine 2 may be based on specific applications of engine 2, such as the size or load of engine 2.

While this invention has been described as having an exemplary design, the present invention may be further modified within the spirit and scope of this disclosure. This application is therefore intended to cover any variations, uses, or adaptations of the invention using its general principles. Further, this application is intended to cover such departures from the present disclosure as come within known or customary practice in the art to which this invention pertains.

What is claimed is:

1. An engine, comprising:
a cylinder having an internal combustion chamber and extending longitudinally;
a cylinder head coupled to the cylinder;
a fuel-fed pre-chamber positioned within a portion of the cylinder head and including a pre-chamber volume and a plurality of nozzle holes extending from the pre-chamber volume;
an ignition source positioned longitudinally above the pre-chamber volume; and
a locating member positioned on at least one of the pre-chamber and the cylinder head and configured to position the pre-chamber in a predetermined rotational orientation within the cylinder head.

2. The engine of claim 1, wherein the locating member is configured to maintain a longitudinal and rotational position of the pre-chamber.

3. The engine of claim 1, wherein the locating member includes a first locating member positioned on the pre-chamber and a second locating member positioned on the cylinder head.

4. The engine of claim 3, wherein the first and second locating members are selected from the group consisting of a pin, a notch, a protrusion, a flat screw, a set screw, a tab, a recess, a shoulder, and a groove.

5. The engine of claim 1, wherein the plurality of nozzle holes are asymmetrically distributed about the pre-chamber.

6. The engine of claim 5, wherein the plurality of nozzle holes includes a first portion of nozzle holes positioned at a first portion of the pre-chamber and a second portion of nozzle holes positioned at a second portion of the pre-chamber, and the first portion of nozzle holes includes more nozzle holes than the second portion of nozzle holes.

7. The engine of claim 5, wherein the plurality of nozzle holes includes a first portion of nozzle holes positioned at a first portion of the pre-chamber and a second portion of nozzle holes positioned at a second portion of the pre-chamber, and each nozzle hole of the first portion has a greater diameter than each of nozzle hole of the second portion.

8. The engine of claim 1, further comprising a retaining clamp configured to retain the pre-chamber within the cylinder head and positioned longitudinally above the pre-chamber volume.

9. An engine, comprising:
a cylinder having a cylinder bore and extending along a longitudinal axis of the cylinder;
a cylinder head coupled to the cylinder;
a fuel-fed pre-chamber positioned within a portion of the cylinder head and including a pre-chamber volume and plurality of nozzle holes extending from the pre-chamber volume, the plurality of nozzle holes having an asymmetrical configuration at a distal portion of the pre-chamber; and
an ignition source positioned longitudinally above the pre-chamber volume.

10. The engine of claim 9, wherein a diameter of at least one of the plurality of nozzle holes is greater than a diameter of a remainder of the nozzle holes.

11. The engine of claim 10, wherein a diameter of the at least one nozzle hole is 0.5-2.0% of a diameter of the cylinder bore.

12. The engine of claim 9, wherein a circumferential separation between a first portion of the plurality of nozzle holes is greater than a circumferential separation between a second portion of the plurality of nozzle holes.

13. The engine of claim 9, wherein an angle relative to the longitudinal axis of the cylinder of at least one nozzle hole is greater than an angle relative to the longitudinal axis of the cylinder of a remainder of the nozzle holes.

14. The engine of claim 9, further comprising a retaining clamp configured to retain the pre-chamber within the cylinder head and positioned longitudinally above the pre-chamber volume.

15. An engine, comprising:
a cylinder extending along a longitudinal axis;
a cylinder head coupled to the cylinder;
a pre-chamber positioned within a portion of the cylinder head and including a pre-chamber volume and plurality of nozzle holes extending from the pre-chamber volume;
at least one electronic fuel valve fluidly coupled to the pre-chamber volume; and
an ignition source positioned longitudinally above the pre-chamber volume.

16. The engine of claim 15, further comprising a fuel conduit fluidly coupled to the at least one electronic fuel valve and the pre-chamber volume and having a length 1-5 times greater than an inner diameter of the fuel conduit.

17. The engine of claim 16, wherein the length of the fuel conduit is 1-3 times greater than the inner diameter of the fuel conduit.

18. The engine of claim 15, wherein the ignition source is a spark plug retained within the pre-chamber.

19. The engine of claim 15, wherein the plurality of nozzle holes having an asymmetrical configuration at a distal portion of the pre-chamber.

20. The engine of claim 15, further comprising a locating member positioned on at least one of the pre-chamber and the cylinder head and configured to position the pre-chamber in a predetermined orientation within the cylinder head.
